(19) United States
(12) Patent Application Publication
(10) Pub. No.: US 2020/0290602 A1
(43) Pub. Date: Sep. 17, 2020

(54) METHOD AND DEVICE FOR CONTROLLING MOVEMENT FOR A SINGLE-TRACK MOTOR VEHICLE

(71) Applicant: Robert Bosch GmbH, Stuttgart (DE)

(72) Inventors: Mathieu Grelaud, Ludwigsburg (DE); Michael Schoenherr, Renningen-Malmsheim (DE)

(21) Appl. No.: 16/753,541

(22) PCT Filed: Oct. 18, 2018
(86) PCT No.: PCT/EP2018/078606

§ 371 Date: Apr. 3, 2020

(30) Foreign Application Priority Data
Nov. 9, 2017 (DE) 10 2017 219 892.3

(51) Int. Cl. B60W 30/085; B60W 50/14; B60W 30/095; B60W 30/16; G08G 1/16

(52) U.S. Cl. CPC B60W 30/085; B60W 50/14; B60W 30/0956; B60W 30/162; B60W 2300/36; B60W 2420/52; B60W 2420/42; B60W 2554/802; G08G 1/166

(57) ABSTRACT

A method for controlling movement for a single-track motor vehicle. The distance from or the speed relative to a vehicle following behind the motor vehicle is sensed by a rear driving-environment sensor system sensing the rearward area behind the motor vehicle. In response to a drop below a distance limiting value or if a relative-speed limiting value is exceeded, warning information is output for the driver of the single-track motor vehicle.

### BACKGROUND INFORMATION

German Patent Application No. DE 10 2012 207 253 A1 describes equipping a braking system for a two-wheeled vehicle with an emergency-braking-situation detection device and an emergency-braking device. In that case, the intention is to design the emergency-braking-situation detection device to detect a dangerous situation that requires emergency braking of the two-wheeled vehicle, and thereupon to output an emergency-braking signal. The emergency braking device has a braking element that is secured to a frame of the two-wheeled vehicle and is movable from a retracted position into a deployed position, and is designed, in reaction to the emergency-braking signal, to move the braking element into the deployed position in mechanical contact with a roadway traveled on by the two-wheeled vehicle, in such a way that a decelerating braking force is exerted on the two-wheeled vehicle due to friction between the braking element and the roadway.

### SUMMARY

The present invention relates to a method for controlling movement for a single-track motor vehicle, in which the distance from or the speed relative to a vehicle following behind the motor vehicle is sensed by a rear driving-environment sensor system sensing the rearward area in back of or behind the motor vehicle, and in response to a drop below a distance limiting value or if a relative-speed limiting value is exceeded, warning information is output for the driver of the single-track motor vehicle. This rear-area monitoring and driver information increase safety for the driver of the single-track motor vehicle.

In accordance with one advantageous development of the present invention, besides the warning information for the driver, in addition, a warning signal is output to the driver of the following vehicle. Single-track motor vehicles may easily be overlooked, particularly in a complex traffic situation, so that this warning information further increases safety.

In accordance with one advantageous refinement of the present invention, in addition, the distance from or the speed relative to a preceding vehicle in front of the motor vehicle, or an obstacle located ahead of the single-track motor vehicle, is sensed by a front driving-environment sensor system sensing the area lying in front of the motor vehicle, and in response to a drop below a distance limiting value or if a speed-limiting value relative to the preceding vehicle is exceeded, a driver-independent braking intervention is carried out.

In accordance with one advantageous embodiment of the present invention, the intensity of the driver-independent braking intervention is a function of the distance from or the speed relative to the vehicle following behind the motor vehicle. The intention is thereby to prevent that, for example, although a crash of the single-track motor vehicle with a preceding vehicle is prevented by an emergency braking, the following vehicle instead runs into the single-track motor vehicle from behind.

In accordance one advantageous development of the present invention, the intensity of the driver-independent braking intervention is reduced if with respect to the following vehicle, there is a drop below a distance limiting value or a relative-speed limiting value is exceeded.

In accordance with one advantageous refinement of the present invention, the rear driving-environment sensor system and the front driving-environment sensor system are in each instance a radar sensor system or a video sensor system. These sensor systems are already widespread in the automobile sector.

In accordance with one advantageous embodiment of the present invention, the single-track motor vehicle is a motorcycle.

In addition, the present invention includes a device containing means which are designed to carry out the method of the present present invention. In particular, it is a control unit in which the program code for carrying out the method according to the present invention is stored.

### BRIEF DESCRIPTION OF THE DRAWINGS

FIG. 1 shows a top view of a motorcycle driving to the right with a preceding automobile.

FIG. 2 shows a top view of a motorcycle driving to the right with a following automobile.

FIG. 3 shows a top view of a motorcycle driving to the right with a preceding automobile and a following automobile.

### DETAILED DESCRIPTION OF EXAMPLE. EMBODIMENTS

Considerably greater vehicle accelerations and decelerations exist in the motorcycle sector than in the automobile sector. That is why following vehicles in particular may be surprised by a strong braking deceleration of a motorcycle. Such a sharp deceleration may occur, e.g., upon activation of an emergency braking assistance system in a motorcycle, and may lead to a collision of the following vehicle with the motorcycle. Therefore, the present invention is based on the use of a sensor system which monitors the road space at the back of the motorcycle and, if the following vehicle comes dangerously close, triggers a warning system or, if possible, diminishes a braking intervention taking place at the motorcycle.

The monitoring of the vehicle area at the back of a motorcycle brings the following possibilities:
Information or warning of the driver of the motorcycle about the following vehicle.
Information or warning of the driver of the following vehicle, if its distance is becoming too small or its relative speed is too great. For example, this is accomplished by activation of the hazard warning signal system, the taillights or other visual or acoustic means.
In the event a brake assist system of the motorcycle is activated, its interventions may take the following vehicle into account.

In this context, the following scenarios may be considered:

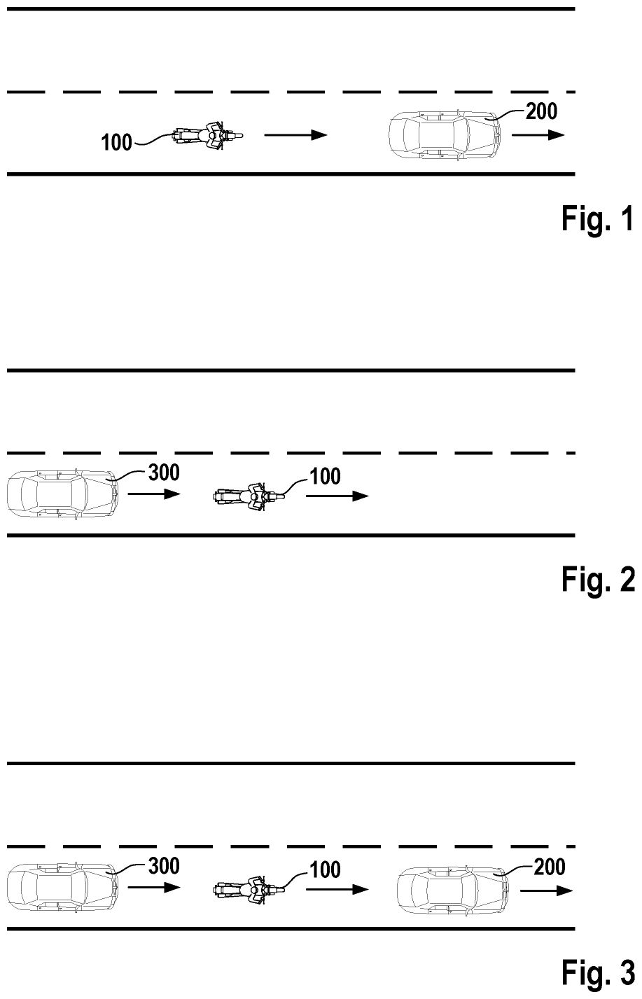

FIG. 1 shows a motorcycle 100 with a preceding vehicle 200. There is no vehicle following behind the motorcycle. Therefore, in this case, the brake assist systems of the motorcycle like, e.g., a distance control to the preceding vehicle, may function in the customary manner.

FIG. 2 shows a motorcycle 100 with a following vehicle 300. If vehicle 300 reduces the distance to motorcycle 100, then the motorcycle may emit warning information directed rearward to the following vehicle, e.g., by automatic activation of the hazard warning flashers or the brake lights. The form of the warning information may also depend on how quickly following vehicle 300 is approaching or how close it is coming to motorcycle 100. In the event the following vehicle is approaching too fast or coming too close, in addition, an activated brake assist function of motorcycle 100 may be aborted or diminished, in order to avoid a rear-end collision by vehicle 300.

FIG. 3 again shows motorcycle 100, both a preceding vehicle 200 and a following vehicle 300 being present. If vehicle 300 reduces the distance to motorcycle 100, then the motorcycle may emit warning information directed rearward to the following vehicle, e.g., by automatic activation of the hazard warning flashers or the brake lights. The form of the warning information may also depend on how quickly following vehicle 300 is approaching or how close it is coming to motorcycle 100.

In the event a brake assist system of motorcycle 100 is activated, both the danger of a collision with preceding vehicle 200 as well as with following vehicle 300 must now be considered. That is, a brake intervention to avoid running into vehicle 200 from behind should only be aborted if the rear driving-environment sensor system detects no substantial danger for a collision with following vehicle 300. cm 1-8. (canceled)

9. A method for controlling movement for a single-track motor vehicle, the method comprising the following steps:
sensing a distance from a following vehicle following behind the single-track motor vehicle or a speed relative to the following vehicle by a rear driving-environment sensor system sensing the rearward area in back of the single-track motor vehicle; and
in response to a the distance from the following vehicle dropping below a distance limiting value or the speed relative to the following vehicle exceeding a relative-speed limiting value, outputting warning information to a driver of the single-track motor vehicle.

10. The method as recited in claim 9, further comprising:
in response to the drop below the distance limiting value or the relative-speed limited value is exceeded, outputting a warning signal to a driver of the following vehicle.

11. The method as recited in claim 9, further comprising:
sensing a distance from a preceding vehicle in front of the single-track motor vehicle or obstacle in front of the single-track motor vehicle, or a speed relative to the preceding vehicle or the obstacle, by a front driving-environment sensor system which senses an area lying in front of the single-track motor vehicle; and
in response to the distance from the preceding vehicle or the obstacle below a distance limiting value exceeding a second limiting value, or the speed relative to the preceding vehicle or the obstacle exceeding a second relative-speed limiting value, carrying out a driver-independent braking intervention.

12. The method as recited in claim 11, wherein an intensity of the driver-independent braking intervention is a function of the distance from or the speed relative to the following vehicle following behind the motor vehicle.

13. The method as recited in claim 12, wherein the intensity of the driver-independent braking intervention is reduced if with respect to the following vehicle, there is a drop below the second distance limiting value or the second relative-speed limiting value is exceeded.

14. The method as recited in claim 9, wherein the rear driving-environment sensor system is a radar sensor system or a video sensor system.

15. The method as recited in claim 11, wherein the front driving-environment sensor system are in each instance a radar sensor system or a video sensor system.

16. The method as recited in claim 9, wherein the single-track motor vehicle is a motorcycle.

17. A device including processor, the device configured to control movement for a single-track motor vehicle, the device configured to:
sense a distance from a following vehicle following behind the single-track motor vehicle or a speed relative to the following vehicle by a rear driving-environment sensor system sensing the rearward area in back of the single-track motor vehicle; and
in response to a the distance from the following vehicle dropping below a distance limiting value or the speed relative to the following vehicle exceeding a relative-speed limiting value, output warning information to a driver of the single-track motor vehicle.
